(19) United States
(12) Patent Application Publication
(10) Pub. No.: US 2014/0156542 A1
(43) Pub. Date: Jun. 5, 2014

(54) SYSTEM FOR MANAGING THE SHIPMENT OF ELECTRONIC COMPONENTS

(71) Applicant: Joseph McKeown, Ann Arbor, MI (US)

(72) Inventor: Joseph McKeown, Ann Arbor, MI (US)

(21) Appl. No.: 13/874,877

(22) Filed: May 1, 2013

Related U.S. Application Data
(60) Provisional application No. 61/640,742, filed on May 1, 2012.

(51) Int. Cl. G06Q 10/00

(52) U.S. Cl. CPC G06Q 10/30
USPC 705/308

(57) ABSTRACT

A system for repurposing electronic components is provided. The system utilizes a distributed software system which assists in the valuation and repurposing of a pre-owned electronic component.

### CROSS-REFERENCE TO RELATED APPLICATIONS

This application claims the benefit of U.S. Provisional Application No. 61/640,742, filed on May 1, 2012. The entire disclosure of the above application is incorporated herein by reference.

### FIELD

The present disclosure relates generally to the distribution of electronic equipment. More particularly, the disclosure relates to methods for improving the recycling of electronic components from using consumers.

### BACKGROUND

This section provides background information related to the present disclosure which is not necessarily prior art.

Thousands of people every year dispose of unwanted electronic components. Unfortunately, these electronic components are laden with heavy metals such as lead which can leach into groundwater. Additionally, often these electronic components can include rechargeable batteries which contain other toxic materials such as cadmium or lithium.

To be sure, disposal of non-functioning electronic components is a highly specialized and demanding complex process. Unfortunately, the recycling of non-functioning electronic components occurs in third-world nations where environmental laws may allow the unintentional release of toxic materials into the environment.

Unlike broken electrical equipment, some electrical components still function which may be usable for another consumer. In this regard, the original owner may wish to upgrade, for instance, a wireless device such as a phone, Smartphone, or Tablet device.

While the recycling of electrical components is certainly the goal, there is a large practice problem that must be overcome. Electronic device suppliers typically supply electrical components to consumer users through commercial avenues or through drop shipments. Occasionally, these organizations will take the old electronic component in return. These old components must be disposed of or reused in an ecologically approved manner.

### SUMMARY

This section provides a general summary of the disclosure, and is not a comprehensive disclosure of its full scope or all of its features.

The method for managing the shipment of an electronic component here fundamentally changes how used or preowned electronic components are recycled by changing how a consumer user is interacted with. In accordance with the method, the recycler supplies a software code to a consumer user which assists in the facilitation of the exchange or return of the used or preowned electronic components. Finally, the consumer user or a third party intermediate initiates the software code to determine the value of a piece of electronic equipment to be recycled and facilitate the shipment of the equipment.

The software code, supplied by the recycler, can perform procedures on the electronic component to assist the recycler in the evaluation of the electronic component to be recycled, in accordance with the preferences of the consumer users. In this way, the recycler supplies a bundled product: The software needed to effectively determine the value of a used electronic component, to facilitate a sale transaction of the used electronic component, and facilitate transportation of the used electronic component to a desired location.

From the consumers' point of view, the evaluation process can be generally subdivided into three stages. The pre-evaluation stage begins when the consumer downloads an application which facilitates the transaction. The evaluation stage begins when the consumer downloads the evaluation application and runs the application, and ends when the consumer ships the used electronic component to the recycler and receives payment. The used electronic device is actually evaluated for its value as a reused electronic device during the evaluation stage.

The method of evaluating the used electronic component disclosed herein impacts how the evaluation is deployed, and optionally how the pre-evaluation and post-evaluation steps are conducted. As used herein, the term “application” means a piece of software code which is downloaded onto a desktop computer or to a cellular device. The application is configured to evaluate not only the model and age of the electronic device, but the condition of hardware and software system associated therewith. The application can facilitate the storage of data on a distributed network or an associated computer.

Additional software applications can be utilized by the system. These include applications which will estimate the value of the used electronic component. Additional applications can facilitate the acceptance of payments, the advertisement of other unused electronic components, or cellular telephone plans and hardware.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B comprise a flow chart showing an exemplary electronic device recycling procedure, useful in understanding the teachings in which the method is performed;

FIG. 2 is a simplified relationship diagram showing the interaction amongst various entities, including the repurposer and the consumer, to recycle or repurpose the electronic component;

FIG. 3 is a series of interrelated flow diagrams illustrating, obtaining, compiling and using electronic component information in the recycling system bundled with the electronic component;

FIG. 4 is a process diagram illustrating a generalized recycling procedure work flow where each step of the work flow may include variation based on consumer preference; and

FIG. 5 is a data structure diagram summarizing how user performance may be compiled and organized as part of the recycling process;

and

FIG. 6 is a database schematic diagram illustrating one embodiment of a computer implemented electronic component repurposing system.

Corresponding reference numerals indicate corresponding parts throughout the several views of the drawings.

### DETAILED DESCRIPTION

Example embodiments will now be described more fully with reference to the accompanying drawings.

In accordance with one preferred embodiment, the method for facilitating the recycling of used electronic components by bundling an evaluation software application with a consumer engaged recycling process. In a presently preferred embodiment, a recycled electronic component is bundled with an evaluation application software and recycling system.

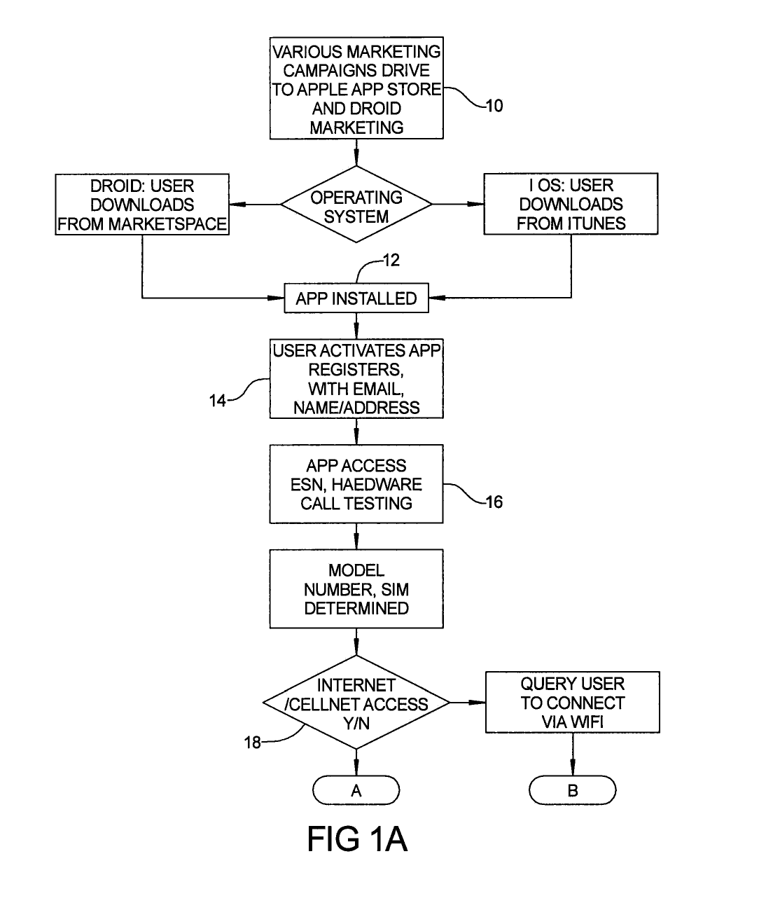

FIGS. 1A and 1B comprise a flow chart showing exemplary electronic device recycling or repurposing procedure, useful in understanding the teaching in which the method is formed. In process block 10, a marketing campaign is conducted to encourage the operator to download an application to their mobile device. After the application is loaded in process block 12, the user activates the application with email, name, and address in process block 14.

In Process block 16, the application performs a series of tests on the electronic device. In this regard, the application accesses the mobile devices ESN, hardware, and performs a test call. In query block 18, the application determines if internet access is available, if internet access is not available, the application determines if WIFI is available. Whether through the cell system, or the WIFI system, the application accesses a pricing database in query block 20 and provides information to the users. The application will the query if the electronic component is in a lost/stolen database, and signal the user if the device can be repurposed.

In process block 24, the user is asked to grade the cosmetics as well as test the LCD screen and the microphone. Based upon the users grading, a final price is set for the device. In query block 26, the user is asked if they want to accept the final price offer. Should the user accept the offer, the user is offered cloud storage for their data in query block 28. Should the user want data services, data related to the phone is uploaded for later download and transfer in process block 30.

The application then provides instructions the user on how to return the electronic component. These instructions can be displayed on the device, or read in an email in process block 32. In process block 43, a bar code for shipment of the electronic component to the re-purposer. In process block 36, the electronic component is evaluated at the re-purposer, scanned, memory wiped and packaged for repurposing. In process block 38, the customer is paid via coupon, check, or gift card.

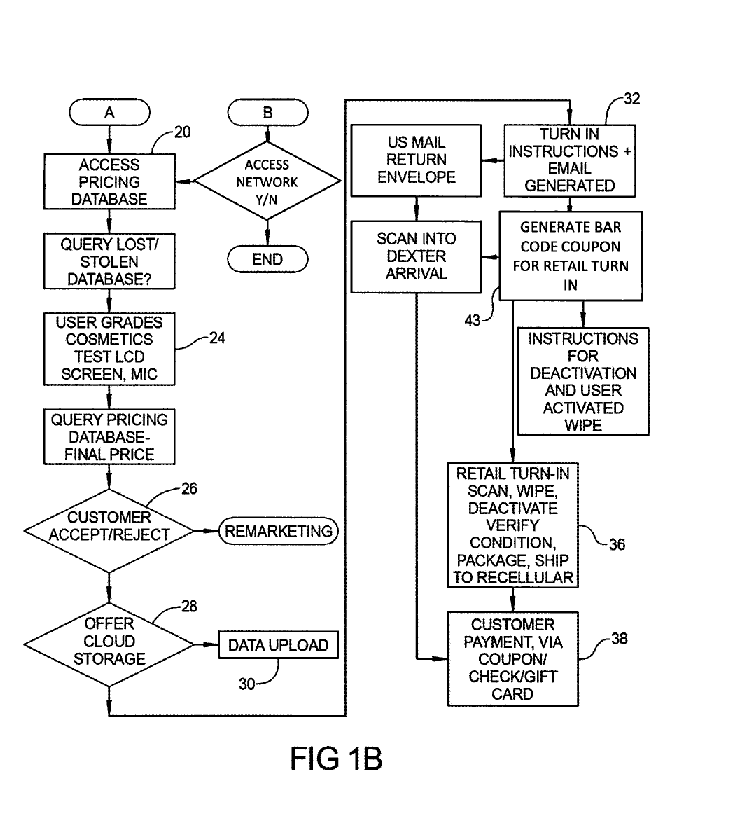

The computer implemented evaluation application supplied by the recycler is illustrated in FIG. 2. The recycler 50 or component supplier 60 supplies not only the evaluation application software 52, payment mechanism 54, but an electronic component recycling or reprocessing system 58.

In one embodiment, the electronic component recycler can train and supply a consumer 62, 62′ or commercial assistant 61 with evaluation software application 52 based on the individual preference of the consumer and the proposed electronic component to be recycled.

A new electronic component supplier provides and supplies to a consumer the evaluation software application, preferably based on preference of the customer, and the electronic hardware to be recycled. The new electronic component manufacturer 60 and the recycler 50 may have a contractual relationship whereby the electronic component manufacturer which normally distributes electronic components such as cell phones or Smart devices can use information such as the customer's preferences and electronic hardware compiled by the recycler to determine what evaluation software application is most needed.

Additionally, if desired, the electronic component manufacturer or distributor may supply applications used in the pre-evaluation procedure and/or post-evaluation procedures to its consumer from time to time, such as at the end of contract duration. The post-evaluation procedure may include facilitating direct mailing of the electronic component overseas, or may include automatic printing of mailing labels.

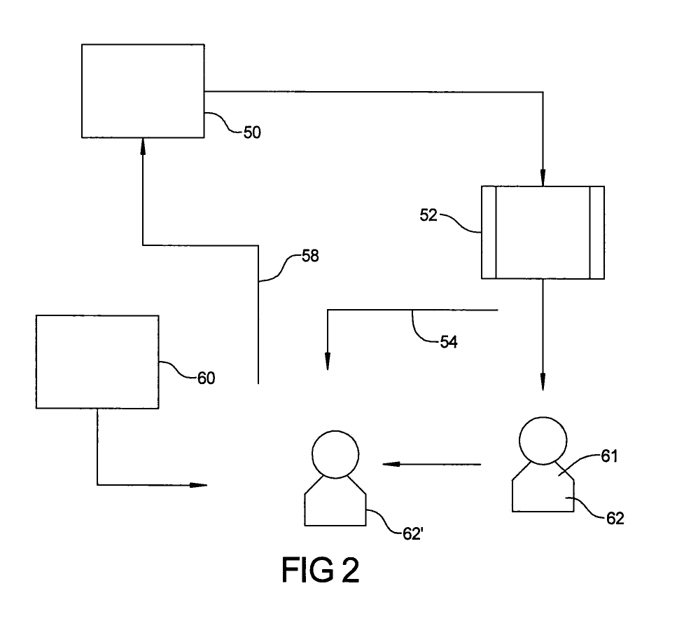

A preferred embodiment follows the process shown in FIG. 3. The process concatenates three interrelated workflows shown generally at x, y and z. In one preferred embodiment the recycler 50 performs and/or supervises each of these workflows. The first workflow, beginning at step 70, compiles information from each consumer prior to recycling. In process block 71 an evaluation of the device is performed. As will be more fully explained, consumer-specific preferences 72 are compiled 74 and stored in a computer-implemented database or memory structure 76 that is used to develop training geared to teach a user how to repurpose their electronic component based on consumer-specific preferences.

The next workflow, depicted at 80, describes how the recycling team members or system are designated and trained by the recycler. The final workflow 82 depicts how a re-purposer processes payment to a user, scheduled and supplied along with the accompanying instruments and supplies to evaluate the electronic component to be recycled. The details of workflows 70, 80, and 82 will next be described.

As at 70, the first step in compiling consumer-specific information is to perform an electronic component assessment 81. Assessment software of the manufacturer or recycler is transferred to a location near or in the component being recycled. The software gathers information about specific preferences the consumer may have. These data, referred to as preferences 90, are then entered as preference information into the computer-implemented database 92, as at 94. The objective here is to gather as much consumer-specific, or supply preferences as possible. For example, if the consumer prefers a certain type data backup or storage or refresh information, then that information would be gathered, entered, and stored. If a consumer prefers a certain type of hardware, such as a particular style of phone or smart device, that information would likewise be entered into database 92.

As shown at 80 and in conjunction with gathering supply side preference data, the manufacturer's or supplier's representative such a sales staff, also can perform a recycling procedure as at 90 and enters recycling technique preference information 90 into the database 92, as at step 96. Because different recycling procedures may necessarily entail different recycling techniques, the representative will endeavor to collect information from as many different types of recycling procedures as he or she is able to observe.

Once the computer-implemented database 92 includes sufficient data to fairly represent the individual consumer's preferences, the information is used to develop consumer-specific training as will now be discussed with reference to workflow. The first step in designating and training recycling team members involves recruiting suitable team members from local markets. Thereafter, electronic component recycling evaluations are conducted on specific techniques based on the particular consumer's preferences as stored in database 92. Thus, the team members-in-training receive specific instruction on supply side preferences and recycling techniques preferences of that consumer. The training on specific techniques is tested as at using quantitative metrics designed to assess the trainee's improvement. As illustrated, steps (training) and (testing) are iteratively performed numerous times until the team member-in-training is able to perform all the different techniques with a high degree of skill. Training is conducted both on an individual basis and also on a team basis, so that each team member-in-training has an opportunity to learn each other team member's role, thereby making them aware of the overall process and allowing one to fill in for the other if circumstances warrant. In one embodiment, performance metric data may be gathered for use later during scheduling.

Database 92 is populated with a list of qualified component specific software components or parameters which are available to evaluate electronic components, as illustrated by the dashed line, with indicia as to which consumer's preferences the team has been trained in. If desired a team can be trained to support more than one consumer, by training that team in the preferences of multiple consumers. Once the software component is selected, the manufacturer or supplier bundles and delivers the software; all of this is based on consumer preferences. In effect, instead of merely supplying evaluation components, instruments and related supplies, the manufacturer includes a service component with the deliverables. This assembled team, together with the consumer, thus performs the recycling procedure.

If desired, the bundled product comprising electrical component (and optionally instruments and related supplies), combined with recycling team services may be offered and invoiced at a single bundled price comprising a materials component (data plan, instruments, supplies) and a labor component (recycling team services).

At this stage in the explanation, it bears noting that the concatenated interconnected workflows of FIG. 3 afford several opportunities to harvest additional information regarding consumer preferences. A designated member of the recycling team may be tasked with the responsibility of seeing that any new or previously undiscovered preferences, revealed during the recycling, are compiled into the database 92.

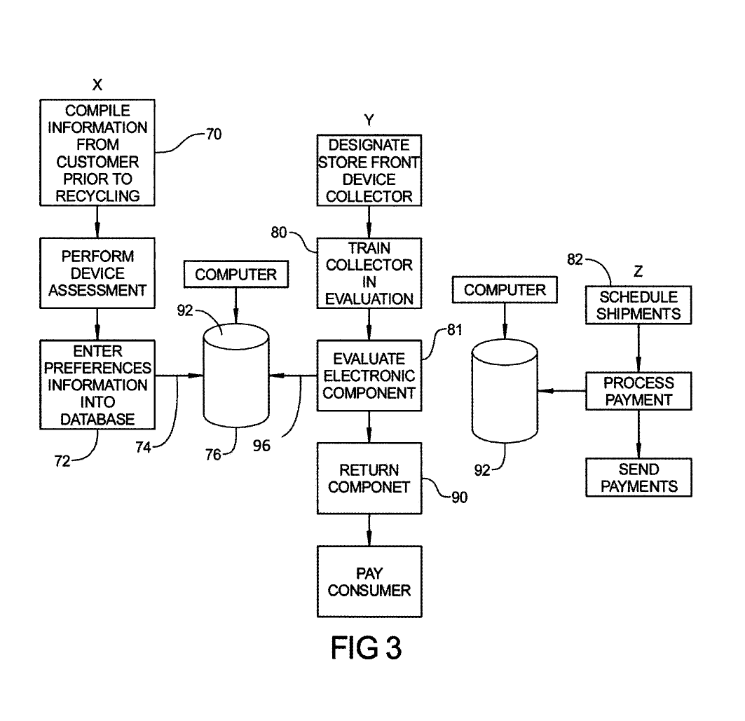

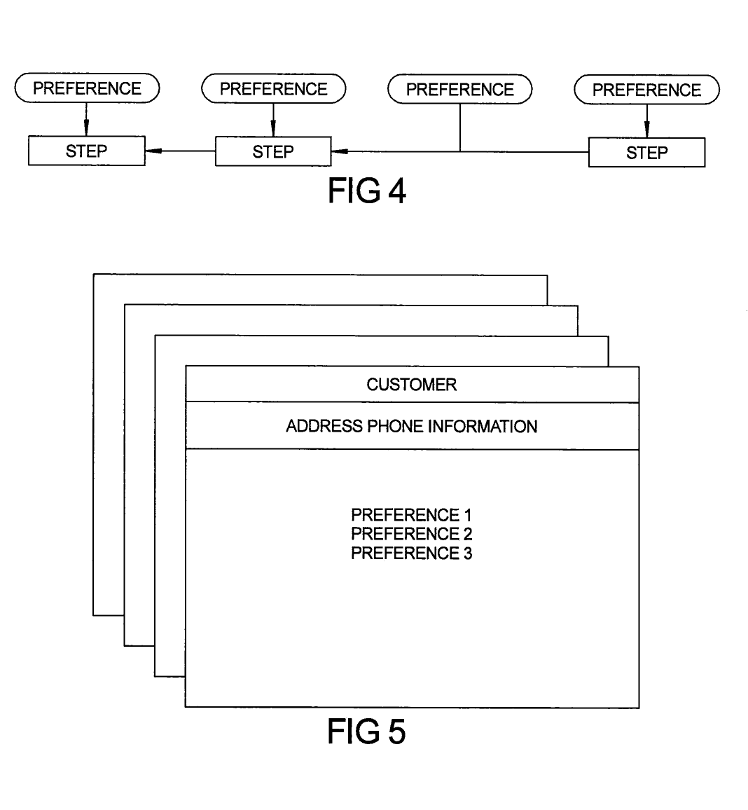

In one embodiment the computer-implemented database 92 that stores consumer preference information preferably accounts for both supply side preferences and recycling technique preferences. Recycling technique preferences are preferably stored on a recycling step-by-step basis. This has been illustrated diagrammatically as the data structure shown in FIG. 5. FIG. 4 shows an exemplary series of recycling steps which may optionally branch into an alternate series of steps. The data structure for storing these steps is designed to be complete. Each individual step within the series of steps corresponds to a particular step in the recycling procedure and is stored in the data structure. With reference to FIG. 1, each of the aggregated steps shown there might correspond to a dozen or more individual steps in FIG. 4. As illustrated, each individual step within the sequence has associated with it a consumer-specific preference. In actual practice, a given consumer may or may not have a particular preference for one or more of the steps. In such case, the computer system would simply store a null value for a step where no preference has been entered.

To better appreciate the complexity and the number of different step-preferences involved refer to FIG. 4 below. FIG. 4 shows the general recycling steps involved in the electronic component recycling, where some of the steps have been annotated to highlight those where variation due to consumer preference is most prevalent. Some of the consumer preference choices have been indicated in parentheses in the described steps. Shown are the general recycling steps involved in electronic component recycling. It will be recalled electronic component recycling was featured, in a highly abbreviated fashion, in FIG. 1.

From the foregoing it will now be appreciated that, when viewed at the industry level, a complex electronic component recycling will entail multiple recycling steps, with many optional branches, and many, many permutations based on individual consumer preferences, resulting in an enormous database. The data structure illustrated in FIG. 5 is designed to store this information.

The data structure of FIG. 5 may be represented in the computer-implemented database 92 as a collection of step sequences associated with each of the different electrical components that are available for use by a given consumer. The data are arranged as complex records that each identify a particular consumer, as at, and that further identify each of the different electrical component devices that may be potentially selected for use by that consumer. Associated with each electrical component are a series of step, with the consumer's preference being also stored, if provided. In addition to the step-specific preferences, a set of general preferences are also indicated for that consumer. The data may be queried and sorted on a consumer-by-consumer basis, thus allowing a training regimen for a particular consumer to be readily developed for use.

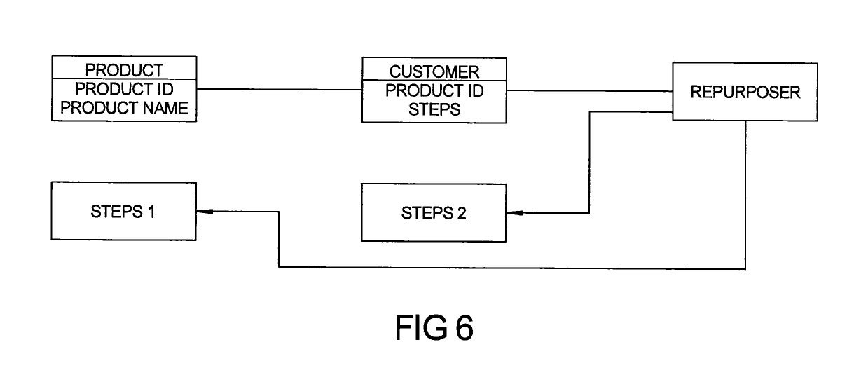

The data structures described in FIGS. 4 can be implemented as computer programming instructions in a variety of different ways. One preferred embodiment employs a relational database schema shown in FIG. 6.

For any given customer, customer identification is stored along with identifiers indicating which consumer is performing the recycling and which product is being installed. The product table is linked to the steps table so that for each product a plurality of steps may be associated. This is dictated by the fact that there are typically many steps performed to install a single product. The consumer-specific table stores a consumer-specific narrative. The consumer-specific table is related to the steps table so that for any given procedural step, a consumer-specific narrative can be appended.

While the relational database embodiment of FIG. 5 represents one way to compile and store consumer preference information, other embodiments are possible. As illustrated, the spreadsheet software application is configured to display a main sheet, which has defined product column regions devoted to each of a plurality of different electrical component products. Product A and Product B are illustrated and it will be appreciated that the spreadsheet can extend laterally to accommodate additional product regions.

The individual installation steps are recorded, such as in chronological order, in the successive rows under the column. Thus the spreadsheet can show, at a glance, each step involved in the electrical componentation process and what consumer specific preferences have been recorded.

If desired, an additional set of columns may be added (not shown) listing each of the different recycling team member functions. Thus a column would be added for the sales assistant or shipping personnel, and so forth. Where a particular team member may be called upon to assist in a given step, that step is flagged with appropriate indicia (e.g., a predetermined character, such as ‘X’) in that member's column. These flags may be used to develop different views of the spreadsheet, such as using pivot tables, showing which consumer specific preferences a given recycling team member must learn.

To accommodate the preferences of multiple consumers, the database 92 can be organized into multiple sheets. By selecting a given consumer (consumer A, consumer B, consumer C), the database table for that consumer's preferences will be displayed.

It will be understood that different spreadsheet arrangements are also possible. Thus, the example shown in FIG. 6 is intended merely to show how a database implementation may be configured to compile and store consumer preference information. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for performing a recycling of an electronic component comprising:
transferring a software application from a computer to a preowned consumer electronic component for running the software application to evaluate a status of the electronic component;
the computer obtaining and compiling information prior to evaluating the electronic component about the electronic component;
the computer supplying repurposing information with the software application;
the software application performing procedures based on information related to the electronic component to assist the consumer in an evaluation of the value of the electronic component in accordance with market value of the electronic component;
facilitating the movement of the electronic component from a first location and a second location; and
providing consideration to the consumer in response to a command by the computer.

2. The method of claim 1 further comprising having the consumer performing physical procedures on the electronic component in accordance with instructions from one of the computer or the software application.

3. The method of claim 1 further comprising the computer instructing a post-evaluation team to supply services by a post-evaluation team member in response to the movement of the electronic component from a first location to a second location.

4. The method of claim 1 wherein the information compiled about the consumer's preferences relate to data backup from the electronic component preferred by the consumer in relation to the supplied software application.

5. The method of claim 1 wherein the information compiled about the consumer's preferences relate to an evaluation computer platform preferred by the consumer in relation to the supplied software application.

6. The method of claim 1 wherein the information compiled about the consumer's preferences relate to the method of hardware evaluation preferred by the consumer in relation to the supplied software application.

7. The method of claim 1 further comprising:
obtaining custom information prior to recycling concerning the physical requirements of the custom software application and providing the custom software application based on the obtained custom information; and
the recycler supplementing the training of the use of the software.

8. The method of claim 1 wherein the supplied software application and the supplied services are collectively supplied at a single bundled price comprising a materials application and a labor application.

9. The method of claim 1 wherein the step of compiling information from the consumer prior to recycling comprises compiling and storing information about the consumer's preferences in a database that relates a preference with an individual step of an software application process associated with the supplied software application.

10. The method of claim 1 wherein the step of compiling information from the consumer prior to recycling includes obtaining information observed during a step of evaluating a data service provider.

11. The method of claim 1 wherein the recycler provides a redeemable coupon together with the supplied software application and the supplied services.

12. The method of claim 1 wherein the supplied software application, the supplied services of the software application and the provided services are collectively supplied at a single bundled price comprising a materials application and a labor application.

13. A method for performing a repurposing of an electronic component comprising:
supplying a software application to a consumer for executing the software application in a first electronic component;
obtaining and compiling information prior to execution of the software application about the consumer's preferences in relation to the supplied software application;
the supplier of the software application executing the software application in accordance with the consumer's preferences based on the compiled information;
the supplier of the software application supplying the services together with the supplied software application; and
the software application performing procedures on the first electronic component to assist the consumer to evaluate a value of an electronic component in accordance with the consumer's preferences learned during said training.

14. The method of claim 13 further comprising training the software component in accordance with the consumer's preferences and supplying the services to the consumer together with the supplied software application.

15. The method of claim 13 further comprising training a post-evaluation team member and supplying the services of the post-evaluation team member together with the supplied software application.

16. The method of claim 13 wherein the information obtained and compiled about the consumer's preferences relate to the storage of data on the second electronic component preferred by the consumer in relation to the supplied software application.

17. The method of claim 13 wherein the information obtained and compiled about the consumer's preferences relate to the software preferred by the consumer in relation to the supplied software application.

18. The method of claim 13 wherein the information obtained and compiled about the consumer's preferences relate to the data-plan preferred by the consumer in relation to the supplied software application.

19. The method of claim 13 further comprising:
obtaining information from the consumer prior to recycling concerning the physical requirements of a custom software application and supplying a custom software application based on the obtained information; and
supplementing the training of software application in the manner of software application the custom software application.

20. The method of claim 13 wherein the supplied software application and the supplied services of the software application are collectively supplied at a single bundled price.

21. The method of claim 13 wherein the step of compiling information from the consumer prior to recycling comprises compiling and storing information about the consumer's preferences in a database that relates a preference with an individual step of an software application process associated with the supplied software application.

22. The method of claim 13 further comprising:
the supplier providing advertisements together with the supplied software application and the supplied services.
